(19) United States
(12) Patent Application Publication
(10) Pub. No.: US 2016/0268709 A1
(43) Pub. Date: Sep. 15, 2016

(54) PRESS-FIT PIN AND COATING METHOD THEREFOR

(71) Applicant: DIEHL METAL APPLICATIONS GMBH, BERLIN (DE)

(72) Inventors: UWE ZEIGMEISTER, TELTOW (DE); CHRISTIAN BUCHHOLZER, BERLIN (DE)

(21) Appl. No.: 15/068,875

(22) Filed: Mar. 14, 2016

(30) Foreign Application Priority Data
Mar. 14, 2015 (DE) 102015003285.2

(51) Int. Cl. H01R 12/58; C25D 7/00; C25D 3/64

(52) U.S. Cl. CPC H01R 12/585; C25D 3/64; C25D 7/00

(57) ABSTRACT

A press-fit pin has a base body made from copper or a copper alloy. The base body of the press-fit pin is coated by electroplating from an alkali-cyanidic electrolyte with a layer of a silver alloy containing more than 50 wt % Ag, the balance being Sn and unavoidable impurities.

### CROSS-REFERENCE TO RELATED APPLICATION

This application claims the priority, under 35 U.S.C. §119, of German application DE 10 2015 003 285.2, filed Mar. 14, 2015; the prior application is herewith incorporated by reference in its entirety.

### BACKGROUND OF THE INVENTION

### Field of the Invention

The invention relates to a method for coating a press-fit pin and to a press-fit pin.

European patent EP 2 596 157 B1 discloses a method for producing a press-fit pin. There a base body is coated by electroplating from methanesulphonic acid solution with a layer formed from a tin alloy.

United States published patent application US 2009/0239398 A1 discloses a press-fit pin which is coated with a layer made from a tin alloy. This tin alloy contains 0.5 to 15 wt % silver.

U.S. Pat. No. 6,361,823 B1 discloses an electroless method for coating a base body of copper or a copper alloy. This base body is coated first with a layer made from tin and subsequently with an outer layer made from an alloy.

DE 10 2005 055 742 A1 discloses a method for producing a contact-suitable layer on a metal element. The contact-suitable layer is formed substantially from tin. It may have intermetallic silver/tin phases with a silver fraction in the range from 25 to 40 wt %.

The aforementioned coatings comprising a silver-containing tin alloy replace earlier coatings which were made from lead-containing tin alloys. The replacement is necessary on account of EU Directive 2002/95/EC, which prohibits the use of lead, as an environmentally harmful substance.

With a layer made from a silver-containing tin alloy, however, there are occasionally in practice whiskers formed that grow out from the layer. Such whiskers may lead to the development of short-circuits.

### SUMMARY OF THE INVENTION

It is accordingly an object of the invention to provide a press-fit pin and a coating method for a press-fit pin which overcome the above-mentioned and other disadvantages of the heretofore-known devices and methods of this general type. The intention more particularly is to specify a method for producing a press-fit pin, and also a press-fit pin, where the propensity to form whiskers is reduced.

With the foregoing and other objects in view there is provided, in accordance with the invention, a method for coating a press-fit pin, the method comprising:
providing a base body made from copper or a copper alloy;
coating the base body by electroplating from an alkali-cyanidic electrolyte at least sectionally with a layer of a silver alloy containing more than 50 wt % Ag, the balance being made up of Sn and unavoidable impurities.

In other words, there is provided a novel method for coating a press-fit pin, a base body made from copper or a copper alloy being coated by electroplating from an alkali-cyanidic electrolyte at least sectionally with a layer of a silver alloy containing more than 50 wt % Ag, the balance being made up of Sn and unavoidable impurities.

In contrast with the prior art, the layer is applied by electroplating to the base body not from an acidic electrolyte, but instead from an alkali-cyanidic electrolyte. The silver alloy forming the layer comprises more than 50 wt % Ag, preferably at least 55 wt % Ag. It has surprisingly emerged that with the method of the invention a largely pore-free attachment of the layer to the base body can be achieved. With the method proposed, in particular, success is achieved in making homogeneous single-phase layers. A press-fit pin produced according to the method of the invention is distinguished by a particularly low propensity to form whiskers.

The electrolyte can be prepared using one of the following silver compounds: silver cyanide, potassium silver cyanide, silver sulphide, silver sulphate. Tin compounds which can be used for preparing the electrolyte are as follows: potassium stannate, sodium stannate, tin oxide, tin sulphate.

The electrolyte, moreover, has been advantageously admixed with at least one of the following compounds: sodium cyanide, potassium cyanide, sodium gluconate, potassium gluconate, ethylenediamine, ammonia, triethanolamine, glycine, thiourea, urea, nitrilotriacetic acid. The aforesaid compounds serve as complexing agents or as conductive salts.

The electrolyte may further have been admixed with at least one of the following further compounds: sodium hydroxide, potassium hydroxide, sodium carbonate, potassium carbonate, potassium sulphide. The aforesaid further compounds act as a complexing agent for tin. Apart from that, the further compounds can be used to adjust the conductivity of the electrolyte.

The electroplate coating is carried out advantageously at a current density in the range from 5 to 20 A/dm². The pH of the electrolyte is usefully adjusted to 7 to 14, preferably to more than 8. The electrolyte can be adjusted at coating to a temperature in the 40 to 90° C. range, preferably 50 to 70° C. More preferably the temperature is 55 to 60° C.

The anode used may comprise an anode made from one of the following materials: graphite, platinized titanium or niobium, silver, tin, silver alloy or tin alloy. In place of the platinization, an anode made from titanium or niobium may also have been coated with a layer comprising a mixed oxide based on Ir, Ta, Nb. Also possible is the use of an anode made from silver and of a further anode made from tin, these anodes being operated in two separate current circuits. Furthermore, anodes may be used in an anolyte with a membrane.

According to one advantageous refinement of the invention, the layer is applied in a thickness 0.1 to 0.8 μm, preferably 0.2 to 0.6 μm. An interlayer of Ni or Cu may be applied by electroplating to the base body before the layer formed from the silver alloy is applied. In this way the adhesion of the layer can be improved.

According to a further refinement, the layer applied to the base body is heated for a duration of 1 to 10 seconds to a temperature in the range from 150 to 500° C., preferably 300 to 400° C. The heating produces crystal growth in the layer. Furthermore, it allows the concentration of Sn in the alloy to be reduced. As a consequence, intermetallic phases of Ag₃Sn or of Ag₄Sn may be formed. Intermetallic phases of this kind are particularly effective at counteracting the formation of whiskers.

Furthermore, the heat treatment may have the effect of formation of further intermetallic phases between the base body and the layer. Further intermetallic phases of this kind consist for example of Cu₆Sn₅ or of Cu₃Sn. If an interlayer made from Ni is provided on the base body, the heat treatment may have the effect of the development of a further intermetallic phase between the Ni interlayer and the layer made from the silver alloy. A further intermetallic phase of this kind is formed from Ni₃Sn₄, for example.

With the above and other objects in view there is also provided, in accordance with the invention, a press-fit pin, comprising:
a base body made from copper or a copper alloy; and
a layer at least sectionally covering said base body, said layer being formed of a silver alloy containing more than 50 wt % Ag, with a balance being made up of Sn and unavoidable impurities.

In other words, the novel press-fit pin has a base body made from copper or a copper alloy and a layer at least sectionally covering the base body, the layer being formed from a silver alloy containing more than 50 wt % Ag, the balance being made up of Sn and unavoidable impurities. The press-fit pin can be produced by the above-summarized method of the invention. Advantageously it contains no lead. With the layer proposed, the formation of whiskers can be effectively counteracted.

According to one advantageous refinement of the invention, the silver alloy comprises more than 63 wt % and less than 90 wt % Ag. Advantageously, the silver alloy comprises 73 wt % to 89 wt % Ag. More preferably the silver alloy comprises 75 wt % to 85 wt % Ag.

The silver alloy is formed more particularly from Ag₃Sn and/or from Ag₄Sn. In particular it is formed from an intermetallic phase of Ag₃Sn or of Ag₄Sn. An intermetallic phase of this kind reliably and assuredly reduces/minimizes the development of whiskers. The silver alloy preferably consists of a single such intermetallic phase to an extent of more than 95%, preferably of more than 99%.

The silver alloy may also be formed from an Ag matrix or an Sn matrix which comprises at least one intermetallic phase of Ag₃Sn and/or of Ag₄Sn.

The layer has a thickness usefully of 0.1 to 0.8 μm, preferably of 0.2 to 0.6 μm. More preferably the thickness of the layer is 0.3 to 0.4 μm.

According to a further advantageous refinement of the invention, an interlayer formed from Ni or Cu is provided between the base body and the layer. The interlayer may have a further thickness of 1.0 to 3.0 μm, preferably 1.1 to 2.5 μm.

The crystals forming the layer have an average crystal size of advantageously 50 to 800 nm, preferably 100 to 600 nm, more preferably 150 to 400 nm.

An exemplary embodiment of the invention is elucidated in more detail below.

For the coating of an electrical plug connector, more particularly of a press-fit pin, by the method of the invention, an electrolyte is used with a composition evident from the table below.

TABLE

| Addition | Concentration | |
|---|---|---|
| silver cyanide | 0.5-10 | g/l |
| potassium stannate | 20-140 | g/l |
| sodium cyanide | 20-140 | g/l |
| sodium hydroxide | 5-120 | g/l |

The pH of the electrolyte is adjusted to a level in the range from 8 to 13 in particular through the addition of sodium hydroxide, potassium hydroxide or the like. The electrolytic deposition of the layer takes place at a temperature in the range from 50 to 70° C. and a current density of 5 to 20 A/dm^{2.}

The concentrations of the silver and tin donor compounds are advantageously adjusted so as to form a single-phase intermetallic compound comprising Ag₃Sn or Ag₄Sn.

The layer deposited on the base body made from copper or a copper alloy may subsequently be heated to a temperature in the range from 300 to 400° C. for a duration of 1 to 10 seconds.

The press-fit pin produced in accordance with the invention is free from lead. The layer silver alloy that is deposited thereon is hard and robust and is notable for a particularly low propensity to form whiskers.

1. A method for coating a press-fit pin, the method comprising:
providing a base body made from copper or a copper alloy;
coating the base body by electroplating from an alkali-cyanidic electrolyte at least sectionally with a layer of a silver alloy containing more than 50 wt % Ag, the balance being made up of Sn and unavoidable impurities.

2. The method according to claim 1, which comprises preparing the electrolyte using a silver compound selected from the group consisting of silver cyanide, potassium silver cyanide, silver sulphide, and silver sulphate.

3. The method according to claim 1, which comprises preparing the electrolyte using a tin compound selected from the group consisting of potassium stannate, sodium stannate, tin oxide, and tin sulphate.

4. The method according to claim 1, which comprises providing an electrolyte having been admixed with at least one compound selected from the group consisting of sodium cyanide, potassium cyanide, sodium gluconate, potassium gluconate, ethylenediamine, ammonia, triethanolamine, glycine, thiourea, urea, and nitrilotriacetic acid.

5. The method according to claim 1, which comprises providing an electrolyte having been admixed with at least one compound selected from the group consisting of sodium hydroxide, potassium hydroxide, sodium carbonate, potassium carbonate, and potassium sulphide.

6. The method according to claim 1, which comprises electroplate coating at a current density in a range from 5 to 20 A/dm^{2.}

7. The method according to claim 1, which comprises adjusting a pH of the electrolyte to more than 7.

8. The method according to claim 1, which comprises, for coating, adjusting the electrolyte to a temperature in a range from 40 to 90° C.

9. The method according to claim 1, which comprises using an anode made from at least one material selected from the group consisting of graphite, platinized titanium, platinized niobium, silver, tin, silver alloy, and tin alloy.

10. The method according to claim 1, which comprises applying the layer at a thickness of between 0.1 and 0.8 μm.

11. The method according to claim 1, which comprises, prior to applying the layer formed from the silver alloy, electroplating an interlayer of Ni or Cu onto the base body.

12. The method according to claim 11, which comprises forming the interlayer in a thickness of 1.0 to 3.0 μm.

13. The method according to claim 1, which comprises heating the layer applied to the base body for a duration of 1 to 10 seconds to a temperature in a range from 200 to 500° C.

14. A press-fit pin, comprising:
a base body made from copper or a copper alloy; and
a layer at least sectionally covering said base body, said layer being formed of a silver alloy containing more than 50 wt % Ag, with a balance being made up of Sn and unavoidable impurities.

15. The press-fit pin according to claim 14, wherein said silver alloy contains more than 63 wt % and less than 90 wt % Ag.

16. The press-fit pin according to claim 14, wherein said silver alloy contains from 73 wt % to 89 wt % Ag.

17. The press-fit pin according to claim 14, wherein said silver alloy contains from 75 wt % to 85 wt % Ag.

18. The press-fit pin according to claim 14, wherein said silver alloy is formed from one or both of Ag₃Sn or from Ag₄Sn.

19. The press-fit pin according to claim 14, wherein said silver alloy is formed from an intermetallic phase of Ag₃Sn or Ag₄Sn.

20. The press-fit pin according to claim 14, wherein said silver alloy is formed from an Ag matrix or an Sn matrix which comprises at least one intermetallic phase of Ag₃Sn and/or Ag₄Sn.

21. The press-fit pin according to claim 14, wherein said layer has a thickness of 0.1 μm to 0.8 μm.

22. The press-fit pin according to claim 14, which further comprises an interlayer formed from Ni or Cu disposed between said base body and said layer.

23. The press-fit pin according to claim 22, wherein said interlayer has a thickness of 1.0 to 3.0 μm.

24. The press-fit pin according to claim 14, wherein said layer is formed of crystals having an average crystal size from 50 to 800 nm.

25. The press-fit pin according to claim 24, wherein said crystals have an average crystal size from 140 to 400 nm.
